(19) United States
(12) Patent Application Publication
(10) Pub. No.: US 2010/0243004 A1
(43) Pub. Date: Sep. 30, 2010

(54) Method and Apparatus for Washing Plastic Bottle Flakes Combining Batch- and Continuous-Mode Processing

(75) Inventors: George SMILOW, Smithtown, NY (US); Curtis W. COZART, JR., Montclair, NJ (US)

Correspondence Address: ETHERTON LAW GROUP, LLC, 2010 E. University Drive, Suite 25, Tempe, AZ, 85281, US

(73) Assignee: PURE TECH PLASTICS, LLC, East Farmingdale, NY (US)

(21) Appl. No.: 12/748,201

(22) Filed: Mar. 26, 2010

Related U.S. Application Data
(60) Provisional application No. 61/165,368, filed on Mar. 31, 2009.

(51) Int. Cl. B08B 3/00

(52) U.S. Cl. 134/34

(57) ABSTRACT

This invention is a method and apparatus for optimizing equipment usage when recycling plastic flake. The apparatus is a hybrid arrangement of batch- and continuous-mode reactor vessels in which the flake and washing liquid are loaded in batches but discharged continuously. This is accomplished by placing a batch reactor of proper volume in front of a continuous reactor of proper volume in series. The batch reactor provides cleaning under controlled conditions, thereby ensuring each flake is washed for substantially the same time and in substantially the same manner. The solid-liquid slurry from the batch reactor is then discharged in batch mode into the continuous reactor. This continuous reactor acts as a surge tank, while at the same time providing additional scrubbing and discharging in a continuous fashion. The output of the continuous reactor is continuously discharged into a dewatering system. Given a desired discharge flow rate from the continuous tank to optimize downstream equipment operation, the size, loading, emptying and processing times of washing equipment can be calculated.

### CROSS-REFERENCE TO RELATED APPLICATIONS

This application claims the benefit of co-pending provisional application No. 61/165,368 filed Mar. 31, 2009.

### FIELD OF INVENTION

This invention relates generally to plastic bottle recycling. This invention relates particularly to a method of washing plastic bottle flake which combines batch- and continuous-mode processing to increase cleaning uniformity and reduce capital cost of the recycling equipment.

### BACKGROUND

The wide variety and increasing popularity of plastic containers for various consumer foodstuffs and other products is a bountiful source of plastic suitable for recycling. These products include milk jugs, plastic soft-drink bottles, and tubs or bottles used for packaging condiments and other products. These plastic articles typically are discarded after a single use and are known as post-consumer scrap plastic.

A variety of polymers are used to make plastic bottles, the material determined by the requirements for the particular containers. For example, plastic milk jugs require structural strength so that the jugs are not easily ruptured and maintain their desired shape when filled with liquid, although they require little shelf life. For these reasons, milk jugs are made of high-density polyethylene (HDPE) in a natural state. Other liquids that don't spoil, such as laundry detergent, are also packaged in HDPE due to the same material requirements, but the package may be colored for marketing purposes. Still other food stuffs such as butter are sold in tubs made from polypropylene because of the specific moldability, preservative and aesthetic properties of that polymer. Other beverages such as soft drinks are packaged in polyethylene terephthalate (PET) because of the aesthetic properties and its ability to contain oxygen and CO2. These PET plastic containers may be clear to permit consumer viewing of the contents, or may be colored to protect the contents from exposure to light. Other polymers are similarly used for packaging, due to their mechanical and aesthetic properties and the availability of them. In all cases, the recycling of these materials requires the removal of non-plastic contamination from the surfaces of the plastic.

The accepted process for performing the removal of contaminates from the plastic is to cut the containers into smaller, free flowing pieces called flakes and remove the contaminates through sorting by size, density, resistance to breakdown by mechanical agitation, magnetism, flowability in air, heat, chemicals and washing.

The heart of plastic bottle flake recycling systems is the hot washing section where the dirty bottle flake is agitated in a liquid with specific mechanical, chemical and temperature conditions. This is accomplished in reactor vessels where the parameters of scrubbing, temperature, chemistry and time are controlled. The reactor vessels discharge into a dewatering device which separates the solids from the liquid, sends the solid to further processing and the liquid to be recovered. Many times, this device is the bottleneck to increasing the throughput of the entire processing line.

Reaction vessels are designed to operate in either batch mode or continuous mode. A batch reactor operates by feeding a certain amount of flake and liquid into the reactor, agitating for a specified period, then discharging the entire lot. The positive aspect of batch reactors is that each individual flake is washed for substantially the same time and in substantially the same manner. To increase capacity, two or more batch reactors are placed in parallel and the washing cycle alternates. While one reactor is filling or emptying, the other is washing. The negative aspect of employing batch reactors in this manner is the amount of equipment necessary to transport the liquid and flake into two reactors. More importantly, since the reactors discharge in batches, the dewatering device downstream must be sized to handle the largest surge.

To avoid the negative aspects of the batch reaction vessels, continuous reactors are used. These reactors are placed in series so that one overflows into the next and so on. Material and liquid loading is simplified because there is only one loading point and, since the discharge is continuous, the downstream dewatering device can be sized for the consistent throughput. The negative aspect of continuous washing is that not every flake is washed uniformly. Some flakes pass through very quickly, while some pass through slowly and may not receive sufficient cleaning.

Therefore, it is an object of this invention to provide a method and apparatus for washing plastic bottle flake that ensures that each flake is assured a minimum amount of cleaning. It is another object to provide a method and apparatus that reduces capital cost due to simplification of the loading system. It is a further object to provide a method and apparatus to consistently feed the downstream equipment so as to optimize its usage and enable downstream equipment to be sized according to the average throughput rather than the throughput surge, thereby saving capital cost and increasing overall processing line capacity.

### SUMMARY OF THE INVENTION

This invention is a method and apparatus for optimizing equipment usage when recycling plastic flake. The apparatus is a hybrid arrangement of batch- and continuous-mode reactor vessels for washing flake in which the flake and washing liquid are loaded in batches but discharged continuously. This is accomplished by placing a batch reactor in front of a continuous reactor in series. The batch reactor provides cleaning under controlled conditions, thereby ensuring each flake is washed for at least a minimum amount of time in substantially the same manner. The solid-liquid slurry from the batch reactor is then discharged in batch mode into the continuous reactor. This continuous reactor acts as a surge tank, while at the same time providing additional scrubbing and discharging in a continuous fashion. The output of the continuous reactor is continuously discharged into a dewatering system. Given a desired discharge flow rate from the continuous tank to optimize downstream equipment operation, the size, loading, emptying and processing times of washing equipment can be calculated

### BRIEF DESCRIPTION OF THE DRAWINGS

FIG. 1 is a schematic illustration of the apparatus of the present invention.

FIG. 2 is flow diagram of the method of the present invention.

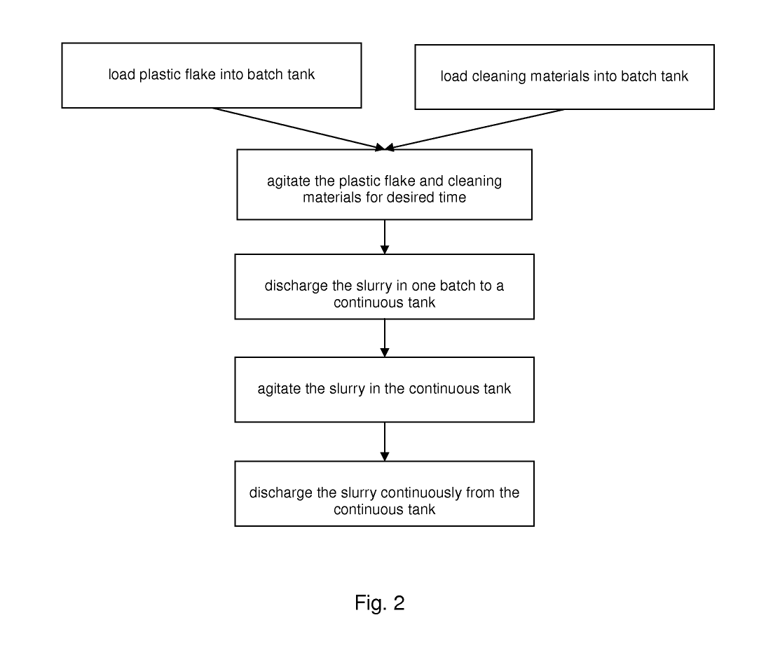

### DETAILED DESCRIPTION OF THE INVENTION

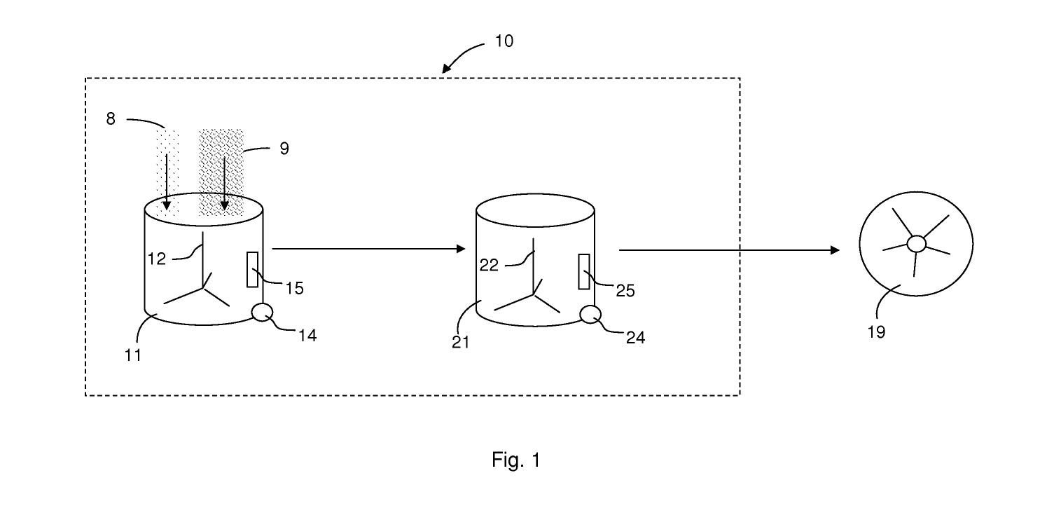

The apparatus used in this invention, referred to generally as 10, can be described most generally as a reactor vessel that operates in batch mode connected in series with a reactor vessel that operates continuously. Reactor vessels are also known in the art as reaction vessels or tanks, and are referred to herein as tanks. FIG. 1 shows a batch tank 11 connected in series in front of a continuous tank 21. The apparatus can be connected to other upstream and downstream equipment, including grinders, separators, filters, dewaterers, dryers, and balers. Preferably the continuous tank is connected to at least a dewaterer 19.

Both batch and continuous tanks provide cleaning under controlled conditions, including temperature, volume, amount of agitation, rate of discharge, rate of fill, solid-liquid ratio, and time. Usually control of the various parameters is electronic and automatic. The tanks include agitators 12, 22 to stir the contents and pumps or valves, or both, to discharge the contents, as is known in the art. FIG. 1 shows a batch tank pump 14 and a continuous tank pump 24. The tanks also include level sensors 15, 25 or level switches. Tanks may also be heated or cooled. Tanks are known in the art and available commercially.

In the method, a batch of plastic flake 9 is loaded into a batch tank 11, using a pump, auger, conveyor or other means of placing a desired quantity of plastic flake in the batch tank before cleaning starts. A liquid is also loaded into the batch tank 11, preferably simultaneously with the plastic flake 9, although the liquid can be loaded before and after the flake, too. The cleaning materials are preferably premixed with the liquid but may be added directly to the tank if desired. A stream of liquid may also be fed in over time if necessary to maintain a desired solids:liquid ratio. Cleaning materials may include liquids and solids, such as water and other aqueous solvents, organic solvents, detergents, surfactants, defoamants, buffers, etc. The form of the materials will determine the equipment used to load them. For example, liquid materials can be poured from bottles or piped in with a pump. Dry materials can be loaded by pouring from bags, or using a pump, auger, or other conveyor. The time necessary to fill the batch tank with solids and liquid, T_{bf}, depends on the flow rate of the equipment and methods used to load the contents. The time necessary to fill the batch tank is preferably minimized in order to either use smaller vessels or to increase throughput. T_{bf} can be minimized by increasing the size of the loading equipment.

The preferred operating volume of the batch tank, V_{b}, is determined by a number of factors, including the size of the batch tank, how much flake is to be cleaned in a given batch, the desired total plastic to be recycled in a given time, the amount of space available for the equipment, and budget. Tradeoffs are often made: for example, a bigger batch tank will enable a larger amount of flake to be cleaned in a given amount of time than a smaller tank, but a bigger tank will be more expensive and need more space than a smaller tank. To ensure the proper operating volume in the batch tank, preferably the batch tank 11 has a level sensor 15 or multiple level switches that monitor the volume and notify the operator before the level is outside desired parameters. For example, if the volume is too low, more flake and liquids can be added; if too high, the excess can be siphoned off and discarded, or the too-large batch can be washed as normal, knowing that downstream configurations and process times may need to be adjusted.

Once loaded, the plastic flake 9 and cleaning materials 8 are agitated in the batch tank 11, and form a slurry. Preferably the agitator 12 should remain running at all times in order to keep the solids in suspension with the liquid. Alternatively, the agitator 12 can be started when liquid the cleaning materials are introduced to the batch tank 11. The slurry is agitated in the batch reactor for sufficient time and under the desired conditions thereby ensuring that each flake is washed according to certain minimum washing standards—that is, with the same agitation, same exposure to cleaning chemicals, and same length of time while in the batch tank. The batch processing time, T_{bp}, is the time necessary to complete the desired washing function under the amount of agitation, temperature and chemistry in the given process. T_{bp} is substantially independent of equipment size or flow rates.

The slurry from the batch tank is then discharged in batch mode into the continuous tank 21 via a pipe, valve or pump (not shown). The time necessary to empty the batch tank, T_{be}, is preferably minimized in order to either use smaller vessels (thus reduce cost) or to increase throughput. T_{be} can be minimized by increasing the flow rate of the emptying equipment, for example by using a higher volume batch tank pump 14.

The slurry flows into the continuous tank 21 in one batch and is preferably agitated to providing additional scrubbing and avoid settling. The volume of the continuous tank 21 between the high and low operating levels is V_{c}. This preferred operating volume of the continuous tank 21 is determined by a number of factors, including the size of the continuous tank, how much flake will be loaded from the batch tank, the desired total plastic to be recycled in a given time, the amount of space available for the equipment, the capacity of the downstream equipment, and budget.

Because the continuous tank 21 takes the entire load from the batch tank 11 at once, the continuous tank 21 acts as a surge tank, while at the same time discharging in a continuous fashion. The slurry is discharged from the continuous tank 21 at a substantially constant rate, F_{ce}, which optimizes the usage of the downstream devices, such as dewatering and drying equipment. Optimization typically occurs when downstream equipment is sized according to the average throughput rather than the throughput surge. This enables smaller—and less expensive—equipment to be used for a given flow rate, thereby saving capital cost and increasing overall processing line capacity.

F_{ce} is also the flow rate through the downstream equipment that optimizes the usage of that equipment, usually about the desired average throughput. Preferably, the relationship of V_{b}, V_{c}, T_{bf}, T_{bp}, T_{be}, and F_{ce} is made so that the continuous tank 21 always has a working level of solids and liquids that is neither too high nor too low. For example, the continuous tank 21 should never reach too high a level as to necessitate that the discharge of the batch tank 11 be stopped. Preferably the continuous tank 21 has a level sensor 25 or multiple level switches that monitor the volume and notify the operator or control system before the level is outside desired parameters. For example, if the volume is too low, another batch can be added from the batch tank or the discharge rate reduced; if the volume is too high, the discharge rate can be increased.

For the first batch, the continuous tank 21 starts to discharge the slurry at a discharge rate, F_{ce}, as soon as the batch is loaded. For subsequent batches, the continuous tank 21 continues discharging the slurry at F_{ce} continuously from the continuous tank 21. Because the downstream equipment, including the dewaterer 19, can be sized according to the average throughput of the continuous discharge rather than the throughput of the batch surge, the capital cost is reduced and overall processing line capacity increased.

The system can be made for any size or flow rate by varying the size of the tanks relative to each other and varying the fill and empty times of each of the tanks, for example by changing pump sizes. A defined throughput can be achieved by varying either the size of the batch tank or the rates at which it is filled and emptied. The volume of the continuous tank is equal to or larger than the volume of the batch tank so that the continuous tank can contain at least the total volume of the batch tank. With proper timing, the operating volume of the continuous tank can be equal to the operating volume of the batch tank, so that just as the continuous tank is emptied, a new batch is loaded from the batch tank. However, the operating volume of the continuous tank may also be larger than operating volume of the batch tank to accommodate more than the volume of a single batch from the batch tank. This is useful to allow for processing tolerances, for example when a batch unloaded into the continuous tank while a small portion of the previous batch is still being discharged from the continuous tank. However, larger tanks are more expensive and therefore do not optimize cost. Preferably the batch tank and continuous tank are the same size and the continuous tank runs out just as a subsequent batch is poured in from the batch tank.

Therefore, by selecting the batch processing time, T_{bp}, and reasonably sized equipment to load and empty the batch tank, the times to fill T_{bf} and empty T_{be} the batch tank can be calculated by dividing the volume of the batch tank V_{b} by the corresponding flow rates of the equipment used to fill (F_{bf}) and empty (F_{be}) the batch tank.

$${T}_{bf} = \frac{{V}_{b}}{{F}_{bf}} and {T}_{be} = \frac{{V}_{b}}{{F}_{be}}$$

A relationship between the desired discharge flow rate F_{ce} from the continuous tank to optimize downstream equipment operation, the loading, emptying and processing times and size of tanks can be calculated using the formulas:

$${F}_{ce} = \frac{{V}_{b}}{{T}_{bf} + {T}_{bp} + {T}_{be}} .$$

where the relationship of the operating volume of the batch tank to the operating volume of the continuous tank is:

V_{b}≦V_{c}

In a preferred embodiment that washes a mixture of PET plastic flake, a batch tank 11 has an operating volume, V_{b}, of 1200 gallons. The batch tank 11 is fitted with a multibladed impeller agitator and a continuous level sensor, which is located in the tank such that it is able to measure even small amounts contained in the tank. A discharge pump with a flow rate, F_{be}, of 220 gallons per minute is connected to the batch tank 11. The batch tank is connected to a continuous tank 21, which has operating volume, V_{c}, of 1200 gallons. The continuous tank 21 is also fitted with a multibladed impeller agitator and a continuous level sensor, which is located in the tank such that it is able to measure even small amounts contained in the tank. A discharge pump with a flow rate, F_{ce}, of 58 gallons per minute is connected to the continuous tank 21.

Approximately 1500 pounds (about 150 gallons) of the plastic flake 9 is loaded into the batch tank 11, at a fill rate of about 300 pounds per minute. The liquid cleaning materials comprise 1% Oakite® RC53 cleaner and 0.02% Oakite® 200-444-001 defoamant, both available commercially from CHEMETALL GmbH, in a 185° F. water solution. About 1050 gallons of liquid cleaning materials are added to the batch tank at a rate of 250 gallons per minute, so that the time necessary to fill the batch tank, T_{bf}, is approximately 5.4 minutes. The agitator 12 is started as soon as the liquid is added. The slurry is allowed to agitate for 10 minutes at 185° F., the desired minimum amount of cleaning. The tank is insulated and live steam is injected directly into the slurry, as necessary, to keep it at the desired temperature. Upon completion of the desired agitation time, the slurry is discharged all at once to the continuous tank 21 through a valve into a pipe which flows at about 220 gallons per minute, thereby making the time to empty the batch tank, T_{be}, about 5.4 minutes. The agitator 22 continues to mix the slurry in the continuous tank 21. For the first batch, the continuous tank 21 starts to discharge the slurry at a discharge rate, F_{ce}, of about 58 gallons per minute as soon as the batch is loaded. For subsequent batches, the continuous tank 21 continues discharging the slurry at about 58 gallons per minute continuously from the continuous tank 21. Preferably the continuous tank runs out of slurry just as each subsequent batch is poured in from the batch tank.

In another embodiment that washes a mixture of HDPE plastic flake, a batch tank 11 has an operating volume, V_{b}, of about 1000 gallons. The batch tank 11 is fitted with a multibladed impeller agitator and a continuous level sensor, which is located in the tank such that it is able to measure even small amounts contained in the tank. A discharge pump with a flow rate, F_{be}, of about 200 gallons per minute is connected to the batch tank 11. The batch tank is connected to a continuous tank 21, which has an operating volume, V_{c}, of about 1000 gallons. The continuous tank 21 is also fitted with a multibladed impeller agitator and a continuous level sensor, which is located in the tank such that it is able to measure even small amounts contained in the tank. A discharge pump with a flow rate, F_{ce}, of about 67 gallons per minute is connected to the continuous tank 21.

Approximately 1500 pounds (about 200 gallons) of the plastic flake 9 is loaded into the batch tank 11, at a fill rate of about 500 pounds per minute. The liquid cleaning materials comprise 1% Oakite® RC7a cleaner and 0.02% Oakite® 200-444-001 defoamant in a 150° F. water solution. The cleaner and defoamant are both available commercially from CHEMETALL GmbH. About 1000 gallons of cleaning materials are added to the tank at a rate of about 200 gallons per minute so that the time necessary to fill the tank, T_{bf}, is approximately 4 minutes. The agitator 12 is started as soon as the liquid is added. The slurry is allowed to agitate for about 6 minutes at about 150° F., the desired minimum amount of cleaning. Upon completion of the desired agitation time, the slurry is discharged all at once to the continuous tank 21 through a valve into a pipe which flows at about 200 gallons per minute, so that the time to empty the batch tank, T_{be}, is about 5 minutes. The agitator 22 continues to mix the slurry in the continuous tank 21. For the first batch, the continuous tank 21 starts to discharge the slurry at a discharge rate, F_{ce}, of about 67 gallons per minute as soon as the batch is loaded. For subsequent batches, the continuous tank 21 continues discharging the slurry at about 67 gallons per minute continuously from the continuous tank 21. Preferably the continuous tank runs out of slurry just as each subsequent batch is poured in from the batch tank.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims

We claim:

1. A method of washing plastic flake comprising:
a. loading plastic flake into a batch tank;
b. loading cleaning materials into the batch tank;
c. agitating the plastic flake and cleaning materials in the batch tank thereby forming a slurry;
d. discharging the slurry to a continuous tank;
e. agitating the slurry in the continuous tank; and
f. discharging the slurry continuously from the continuous tank.

2. The method of claim 1 further comprising removing contaminates from the plastic flake while it is agitating.

3. The method of claim 1 further comprising dewatering the discharge from the continuous tank.

4. The method of claim 1 wherein the agitation in the batch tank is for at least the time needed to achieve minimum cleaning.

5. The method of claim 1 wherein volume of the batch tank is the same size as the volume of the continuous tank.

6. The method of claim 1 wherein discharging the slurry continuously from the continuous tank occurs at a rate that optimizes downstream equipment utilization.

7. A method of washing plastic flake comprising:
a. loading a first amount of plastic flake into a batch tank;
b. loading a first amount cleaning materials into the batch tank;
c. agitating the plastic flake and cleaning materials in the batch tank thereby forming a slurry;
d. discharging the slurry in a first batch to a continuous tank;
e. agitating the slurry in the continuous tank; and
f. discharging the slurry continuously from the continuous tank.

8. The method of claim 7 further comprising:
a. loading a second amount of plastic flake into a batch tank after discharging the slurry in a first batch to a continuous tank;
b. loading a second amount cleaning materials into the batch tank after discharging the slurry in a first batch to a continuous tank;
c. discharging the slurry in a second batch to the continuous tank.

9. The method of claim 7 wherein discharging the second batch of slurry to the continuous tank occurs at nearly the same the continuous tank runs out of the first batch of slurry.

10. The method of claim 7 further comprising removing contaminates from the plastic flake while it is agitating.

11. The method of claim 7 further comprising dewatering the discharge from the continuous tank.

12. The method of claim 7 wherein the agitation in the batch tank is for an amount of time to achieve minimum cleaning.

13. The method of claim 7 wherein volume of the batch tank is the same size as the volume of the continuous tank.

14. The method of claim 7 wherein discharging the slurry continuously from the continuous tank occurs at a rate that optimizes downstream equipment utilization.

15. A method of washing plastic flake comprising:
a. loading plastic flake and cleaning materials into a batch tank in a first period of time, T_{bf}, to form a slurry;
b. agitating the plastic flake and cleaning materials for a second period of time, T_{bp},
c. discharging the slurry in one batch to a continuous tank in a third period of time, T_{be};
d. agitating the slurry in the continuous tank having a volume of V_{c}; and
e. discharging the slurry continuously from the continuous tank at a flow rate F_{ce}, where
$${F}_{ce} = \frac{{V}_{b}}{{T}_{bf} + {T}_{bp} + {T}_{be}} .$$

16. The method of claim 15 further comprising removing contaminates from the plastic flake while it is agitating.

17. The method of claim 15 further comprising dewatering the discharge from the continuous tank.

18. The method of claim 15 further comprising setting the second period of time is at least the time needed to achieve minimum cleaning.

19. The method of claim 15 further comprising setting V_{b} substantially equal to V_{c}.

20. The method of claim 15 further comprising setting F_{ce} to the flow rate needed to optimize downstream equipment operation.
